(19) United States
(12) Patent Application Publication
(10) Pub. No.: US 2025/0239736 A1
(43) Pub. Date: Jul. 24, 2025

(54) Busbar with Clad Member Attached

(71) Applicant: LG Energy Solution, Ltd., Seoul (KR)

(72) Inventor: Jong Min Lim, Daejeon (KR)

(73) Assignee: LG Energy Solution, Ltd., Seoul (KR)

(21) Appl. No.: 18/703,543

(22) PCT Filed: Sep. 7, 2023
(86) PCT No.: PCT/KR2023/013407

§ 371 Date: Apr. 22, 2024

(30) Foreign Application Priority Data
Sep. 8, 2022 (KR) 10-2022-0114263

(51) Int. Cl. H01M 50/503; H01B 5/02; H01M 50/516; H01M 50/522

(52) U.S. Cl. CPC H01M 50/503; H01B 5/02; H01M 50/516; H01M 50/522

(57) ABSTRACT

A busbar includes a busbar body made of an electrically conductive material and a clad member added to a coupling portion of the busbar body coupled to a counterpart. The clad member is constituted by two kinds of metals joined to each other, and the clad member is coupled to the busbar body by welding. The clad member is attached to only the part of the busbar that is coupled to the counterpart as a means configured to prevent corrosion of the busbar, whereby it is possible to prevent defects during formation of a plated portion. A battery pack including the same is also provided.

### CROSS-REFERENCE TO RELATED APPLICATIONS

The present application is a national phase entry under 35 U. S. C. $371 of International Application No. PCT/KR2023/013407, filed on Jul. 9, 2023, which claims priority from Korean Patent Application No. 10-2022-0114263, filed on Sep. 8, 2022, all of which are incorporated herein by reference.

### TECHNICAL FIELD

The present disclosure relates to a busbar with a clad member attached. More particularly, the present disclosure relates to a busbar having a clad member attached to a part of the busbar that is coupled to a counterpart in order to prevent corrosion of an aluminum busbar and to remedy difficulty of plating.

### BACKGROUND ART

Lithium secondary batteries, which are rechargeable and have high energy density, have attracted attention as a new energy source with environmentally-friendly characteristics not only because the lithium secondary batteries can drastically reduce the use of fossil fuels but also because the lithium secondary batteries do not generate by-products from the use of energy.

Lithium secondary batteries are in the limelight as an energy source not only for wearable devices or portable devices but also for devices having high power and high energy density, such as electric vehicles.

For use as an energy source having high power and high energy density, plurality of lithium secondary batteries is connected to each other in series and/or parallel to constitute a battery module, and other components configured to sense and control a battery pack are added to a plurality of battery modules to constitute the battery pack.

A busbar is used as a part configured to electrically connect a plurality of battery cells to each other or to electrically connect a plurality of battery cells to a battery pack connector.

In connection therewith, FIG. 1 is a perspective view of a conventional busbar.

Referring to FIG. 1, the busbar 10 includes a busbar body 11 and a plated portion 20 formed on a part of an outer surface of the busbar body 11.

When a counterpart made of nickel or copper is coupled to an aluminum busbar, the aluminum busbar may be corroded due to galvanic corrosion. In order to prevent this, the aluminum busbar is plated with nickel.

When the aluminum busbar is to be wire-welded to a battery cell, however, aluminum of the part of the busbar that is to be wire-welded to the battery cell must be exposed. For this reason, the part of the busbar that is to be wire-welded is not nickel-plated such that aluminum is exposed, and the remaining part of the busbar is plated with nickel. When only a part of the busbar is plated with nickel, as described above, a process of masking the part that does not need to be plated with nickel using tape, etc. and a process of removing the masking tape after plating are required.

When plating is outsourced, the busbar must be sent to an outsourcing company and then must be received from the outsourcing company. This reduces productivity of a busbar manufacturing process.

In addition, plating may be performed on a larger area than the actual area that needs to be plated for the convenience of the masking process, and poor masking may result in poor plating, such as smudging by a plating

### Solution

In connection therewith, Korean Patent Application Publication No. 2021-0155526 (2021.12.23) (hereinafter “Patent Document 1”) discloses a battery module having a busbar frame connected to a battery cell stack constituted by a plurality of battery cells stacked, busbars located on the busbar frame, and sacrificial positive electrode portions provided under the busbars. In Patent Document 1, the sacrificial positive electrode portions are provided under the busbars so as to be adjacent thereto in order to prevent short circuit between the busbars due to corrosion of the busbars.

In Patent Document 1, when lower parts of the busbars are immersed in electrolytic solutions leaked from the battery cells, the sacrificial positive electrode portions located at the immersed parts are ionized into the electrolytic solutions and disappear, whereby the busbar parts located above the sacrificial positive electrode portions and the busbar parts located under the sacrificial positive electrode portions are separated from each other. As a result, it is possible to prevent connection between a lower end of one busbar and a lower end of one another busbar adjacent thereto through corrosion, whereby it is possible to prevent short circuit.

That is, Patent Document 1 employs the configuration in which the sacrificial positive electrode portions are provided adjacent to the busbars in order to prevent problems caused by corrosion of the busbars.

Therefore, there is a need for technology capable of preventing corrosion of a busbar even when the busbar is coupled to a counterpart made of a different material from the busbar and solving the problem of poor plating.

### DISCLOSURE

### Technical Problem

An aspect of the present invention has been made in view of the above problems, and it is an object of the present invention to provide a busbar with a clad member attached to prevent corrosion of the busbar even when the busbar is coupled to a counterpart made of a different material from the busbar and to solve the problem of poor plating during plating of the busbar.

### Technical Solution

A busbar according to an aspect of the present invention to accomplish the above object includes a busbar body made of an electrically conductive material and a clad member added to a coupling portion of the busbar body, the coupling portion being configured to be coupled to a counterpart, wherein the clad member is constituted by two kinds of metals joined to each other, and the clad member is coupled to the busbar body by welding.

The busbar body may include aluminum.

One of the two kinds of metals may be the same material as the busbar body.

A first metal of the two kinds of metals constituting the clad member may be coupled to the busbar body, the first metal being the same material as the busbar body.

A second metal joined to the first metal of the clad member may be a material having a higher potential than the busbar body.

A through-hole may be formed through each of the clad member and the coupling portion of the busbar body such that screw fastening is performed in the state in which the clad member is attached to the busbar body.

The coupling portion of the busbar body to which the clad member is added may be provided with a recess configured to allow the clad member to be inserted thereinto.

The busbar body may include a wire weld portion configured to be electrically connected to a plurality of battery cells and an integrating portion provided at one end of the wire weld portion, the integrating portion being provided with the coupling portion configured to be coupled to the counterpart, portion may be configured to have a structure in which a plurality of flat bars extends so as to be perpendicular to the integrating portion.

The coupling portion may be formed at a middle part of the integrating portion.

The coupling portion may be formed at a bent surface of at least one end of the integrating portion.

An aspect of the present invention provides a battery pack including a plurality of battery cells electrically connected to each other using the busbar.

In addition, an aspect of the present invention may provide various combinations of the above solving means.

### Advantageous Effects

As is apparent from the above description, in a busbar according to an aspect of the present invention, a clad member made of the same material as a busbar body is attached to a coupling portion of the busbar body, whereby it is possible to secure the force of coupling between the clad member and the busbar by welding.

In addition, it is possible to obtain the same effect as the conventional case in which a plated part is formed so as to be unnecessarily wide even though the clad member is attached only to the coupling portion of the outer surface of the busbar body and to achieve cost reduction.

### DESCRIPTION OF DRAWINGS

FIG. 1 is a perspective view of a conventional busbar.

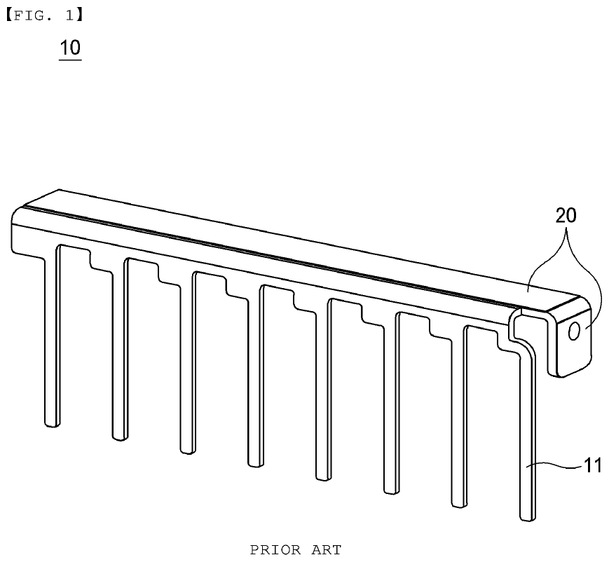

FIG. 2 is a perspective view of a busbar according to a first embodiment.

FIG. 3 is a perspective view of a busbar according to a second embodiment.

FIG. 4 is a perspective view of a busbar according to a third embodiment.

FIG. 5 is an enlarged view showing coupling between the busbar according to an embodiment of the present invention and a counterpart.

### DETAILED DESCRIPTION

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description of the invention and the claims of the present application, singular forms are intended to include plural forms unless mentioned otherwise.

Also, in the description of the invention and the claims of the present application, “or” includes “and” unless mentioned otherwise. Therefore, “including A or B” means three cases, namely, the case including A, the case including B, and the case including A and B.

Hereinafter, embodiments of the present invention will be described in detail with reference to the drawings.

In an embodiment of the present invention, in order to prevent galvanic corrosion of a busbar, a clad member constituted by two kinds of metals joined to each other is added only to a coupling portion of the busbar that needs to be coupled to a counterpart, instead of plating a large region of the busbar, whereby it is possible to obtain the same effect as formation of anti-corrosion plating.

In galvanic corrosion, when different metals come into contact with an electrolytic solution, electrons move due to the difference in potential between the two metals, whereby the rate of corrosion in the metal having lower potential is accelerated.

As the busbar corrodes, resistance increases, and therefore it is necessary to protect the part of the busbar that needs to be coupled to the counterpart from corrosion.

In an embodiment of the present invention, therefore, a clad member is attached to the part of a busbar body that needs to be coupled to the counterpart other than the part of the busbar body that needs to be exposed for wire welding with battery cells, whereby it is possible to obtain the same effect as plating.

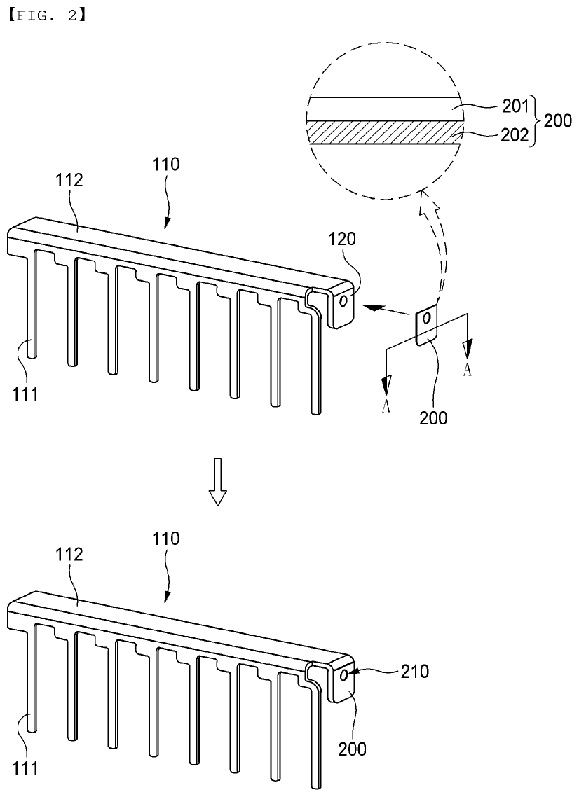

FIG. 2 is a perspective view of a busbar according to a first embodiment.

Referring to FIG. 2, the busbar 100 includes a busbar body 110 made of an electrically conductive material and a clad member 200 added to a coupling portion 120 of the busbar body 110 that is coupled to a counterpart, wherein the clad member 200 is constituted by two kinds of metals joined to each other. In addition, the clad member 200 is coupled to the busbar body 110 by welding.

The counterpart refers to a member that is coupled to the busbar and is not specifically limited.

In order to prevent corrosion of the coupling portion 120 of the busbar body 110, a metal having a higher potential than the busbar body 110 may be attached thereto, and attaching a metal made of a different material from the busbar body 110 to the busbar body 110 by welding may be problematic for adhesion.

When the busbar body 110 is made of a first metal, therefore, the two kinds of metals constituting the clad member 200 may be a first metal 201, which is the same material as the busbar body 110, and a second metal 202, which is a different material from the first metal 201, and the first metal 201 of the clad member 200 may be coupled to the busbar body 110.

For example, the busbar body 110 may be made of a material including aluminum, which exhibits excellent electrical conductivity. At this time, the first metal 201 of the clad member 200 may be a material including aluminum, which is the same material as the busbar body 110. If the first metal 201 is coupled to the busbar body 110 by welding when the clad member 200 is coupled to the busbar body 110, therefore, coupling between the same kinds of metals is achieved, whereby it is possible to obtain excellent weld strength.

The second metal 202 joined to the first metal 201 of the clad member 200, which is provided to prevent corrosion of the busbar body, may be a metal having a higher potential than the busbar body. For example, when the first metal is aluminum, the second metal may be nickel.

The counterpart may be disposed in contact with the second metal 202 of the clad member 200 in the state in which the clad member 200 is attached to the busbar body 110, and the busbar body 110 and the counterpart may be coupled to each other by screw fastening. A through-hole 210 may be formed through each of the clad member 200 and the coupling portion 120 of the busbar body 110.

The thickness of each of the first metal 201 and the second metal 202 constituting the clad member 200 may be freely set. For example, the thickness of the first metal 201 may be set to 0.1 T and the thickness of the second metal 202 may be set to 0.1 T such that the total thickness of the clad member 200 is 0.2 T.

In the clad member, the first metal is a metal coupled to the busbar body and is a material that contributes to securing the force of coupling with the busbar body. Consequently, the first metal may be configured to have the minimum thickness required to be coupled to the busbar body, and the second metal may be configured to have the minimum thickness that is attachable to the first metal during manufacture of the clad member.

When the thickness of each of the first metal and the second metal constituting the clad member is minimized, as described above, it is possible to reduce the weight of the entirety of the busbar when the clad member is attached to the busbar body and to minimize manufacturing costs.

In the busbar 100 according to the first embodiment, the busbar body 110 includes a wire weld portion 111 configured to be electrically connected to a plurality of battery cells and an integrating portion 112 provided at one end of the wire weld portion 111, the integrating portion being provided with the coupling portion 120, wherein the wire weld portion 111 is configured to have a structure in which a plurality of flat bars extends so as to be perpendicular to the integrating portion 112.

The coupling portion 120 is formed at a bent surface of at least one end of the integrating portion 112, and the clad member 200 is coupled to the coupling portion 120.

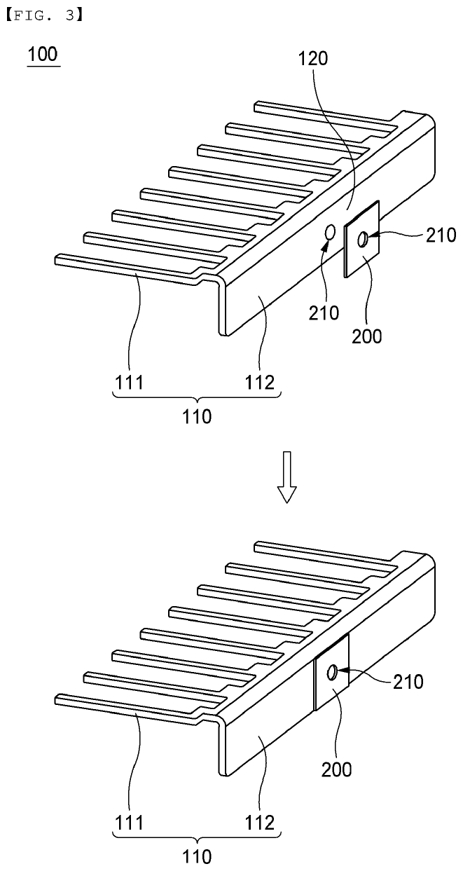

FIG. 3 is a perspective view of a busbar according to a second embodiment.

Referring to FIG. 3, the busbar 100 is different in structure from the busbar according to the first embodiment.

In the busbar 100 according to the second embodiment, a busbar body 110 includes a wire weld portion 111 configured to be electrically connected to a plurality of battery cells and an integrating portion 112 provided at one end of the wire weld portion 111, the integrating portion 112 being provided with a coupling portion 120 configured to be coupled to a counterpart, wherein the wire weld portion 111 is configured to have a structure in which a plurality of flat bars extends so as to be perpendicular to the integrating portion 112. The coupling portion 120 is formed at a middle part of the integrating portion 112, and a clad member 200 is coupled to the coupling portion 120.

As to materials for the busbar body 110 and the clad member 200 and a through-hole 210 formed through each of the clad member 200 and the coupling portion 120 of the busbar body 110, the description of the busbar according to the first embodiment is equally applicable to the busbar according to the second embodiment.

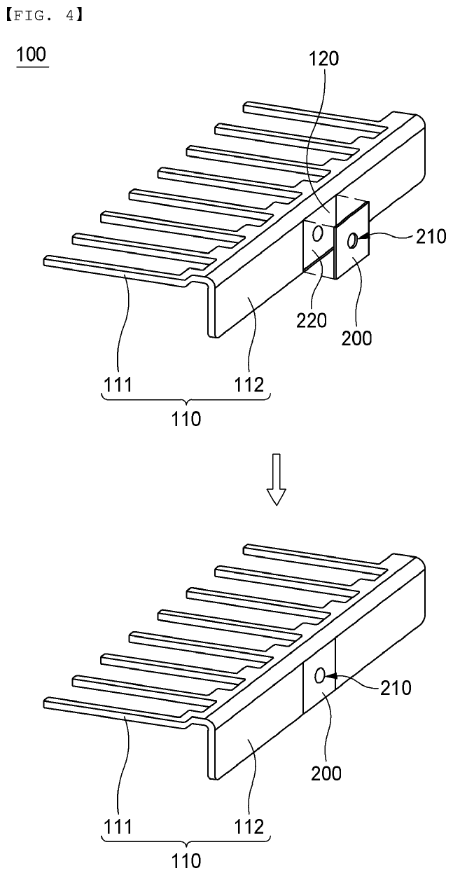

FIG. 4 is a perspective view of a busbar according to a third embodiment.

Referring to FIG. 4, the busbar according to the third embodiment is different from the busbar according to the second embodiment in that a coupling portion 120 of a busbar body 110 to which a clad member 200 is added is provided with a recess 220, into which the clad member 200 is inserted.

If the depth of the recess 220 is formed so as to be the same as the depth of the clad member 200, an outer surface of the busbar body 110 and an outer surface of the clad member 200 may be formed in the same plane when the clad member 200 is mounted in the recess 220 of the busbar body 110, whereby an outer surface of an integrating portion 112 in the state in which the clad member 200 is inserted may be generally flat.

As to materials for the busbar body 110 and the clad member 200 and a through-hole 210 formed through each of the clad member 200 and the coupling portion 120 of the busbar body 110, the description of the busbar according to the first embodiment is equally applicable to the busbar according to the third embodiment.

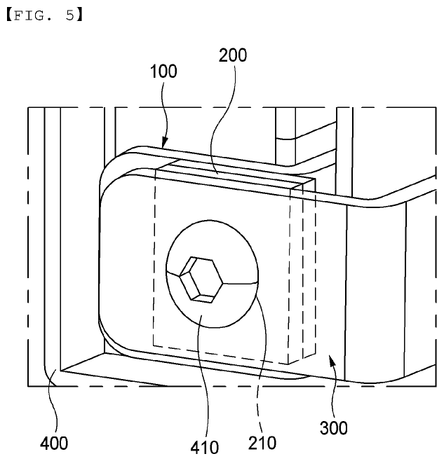

FIG. 5 is an enlarged view showing coupling between the busbar according to an embodiment of the present invention and a counterpart.

FIG. 5 is a partial enlarged view of a battery pack 400 in which a plurality of battery cells is electrically connected to each other using the busbar 100 according to the first embodiment, showing an outer surface of one side of the battery pack 400 to which the coupling portion of the busbar 100 is exposed as an enlarged view.

Referring to FIG. 5, the first metal of the clad member 200 is coupled to the coupling portion of the busbar 100 exposed to the outer surface of the battery pack 400, and the counterpart 300 is coupled to the second metal of the clad member 200.

In order to couple the counterpart 300 to the busbar 100, a screw 410 may be inserted through the through-hole 210 formed in each of the coupling portion and the clad member 200 and may be fastened to an insert nut located in the battery pack.

In a specific example, the surface of the counterpart 300 may be plated with nickel in order to prevent corrosion of the counterpart. For example, a busbar made of copper may be used as the counterpart, and the part of the busbar that contacts the second metal may be plated with nickel.

When the second metal of the clad member 200 is nickel, welding between the second metal of the clad member and the nickel-plated portion of the counterpart is welding between the same kinds of metals, whereby it is possible to secure high coupling force.

In addition, when screw fastening is performed in addition to coupling by welding, it is possible to achieve secure coupling between the busbar and the counterpart.

As described above, the clad member may be attached to only the coupling portion of the busbar body in order to prevent corrosion of the part of the busbar that is coupled to the counterpart. As a result, a busbar body plating process, a masking process, and a mask removing process may be omitted, whereby it is possible to simplify a busbar manufacturing process and to reduce manufacturing costs. In addition, it is possible to obtain the same effect as plating while preventing problems caused by poor plating.

Those skilled in the art to which the present invention pertains will appreciate that various applications and modifications are possible within the category of the present invention based on the above description.

### DESCRIPTION OF REFERENCE NUMERALS

10, 100: Busbars
11, 110: Busbar bodies
20: Plated portion
111: Wire weld portion
112: Integrating portion
120: Coupling portion
200: Clad member
201: First metal
202: Second metal
210: Through-hole
220: Recess
300: Counterpart
400: Battery pack
410: Screw

1. A busbar comprising:
a busbar body including an electrically conductive material; and
a clad member configured to be coupled to a coupling portion of the busbar body, wherein the coupling portion is configured to be coupled to a counterpart,
wherein the clad member includes a first metals and a second metal joined to each other, and
wherein the clad member is configured to be coupled to the busbar body by welding.

2. The busbar according to claim 1, wherein the busbar body includes aluminum.

3. The busbar according to claim 1, wherein one of the first and second metals is the same as a material of the busbar body.

4. The busbar according to claim 3, wherein the first metal is coupled to the busbar body and is the same as the material of the busbar body.

5. The busbar according to claim 4, wherein the second metal has an electric potential being higher than an electric potential of the busbar body.

6. The busbar according to claim 1, wherein each of the clad member and the coupling portion include a through-hole configured to receive a fastener, wherein the fastener is configured to couple the clad member to the busbar body.

7. The busbar according to claim 1, wherein the coupling portion includes a recess configured to accommodate the clad member therein.

8. The busbar according to claim 1, wherein
the busbar body comprises:
a wire weld portion configured to be electrically connected to a plurality of battery cells; and
an integrating portion joined to the coupling portion and being provided at one end of the wire weld portion,
wherein the wire weld portion includes a plurality of flat bars extending perpendicular to a primary surface of the integrating portion.

9. The busbar according to claim 8, wherein the coupling portion is disposed on a middle region of the integrating portion.

10. The busbar according to claim 8, wherein the coupling portion is disposed on a bent surface of at least one end of the integrating portion.

11. A battery pack comprising a plurality of battery cells electrically connected to each other by the busbar according to claim 1.
